(19) United States
(12) Patent Application Publication
(10) Pub. No.: US 2020/0086337 A1
(43) Pub. Date: Mar. 19, 2020

(54) METHOD AND DEVICE FOR PRODUCING FOAM COMPOSITE ELEMENTS

(71) Applicant: Covestro Deutschland AG, Leverkusen (DE)

(72) Inventors: Ralf Koester, Leverkusen (DE); Heinrich-Peter Sobik, Leverkusen (DE); Uwe Kuenzel, Leverkusen (DE); Thomas Rüb, Leverkusen (DE); Catherine Lövenich, Bergisch Gladbach (DE)

(21) Appl. No.: 16/471,952

(22) PCT Filed: Jan. 30, 2018
(86) PCT No.: PCT/EP2018/052223

§ 371 Date: Jun. 20, 2019

(30) Foreign Application Priority Data
Jan. 31, 2017 (EP) 17154065.1

(51) Int. Cl. B05B 7/00; B05B 7/24; B05D 1/02

(52) U.S. Cl. CPC B05B 7/0018; B05D 1/02; B05B 7/2486

(57) ABSTRACT

The present disclosure relates to a process and an apparatus for applying a foamable reaction mixture to a moving outerlayer, the reaction mixture being applied from discharge openings on the outerlayer, and the outerlayer moves at a speed of ≥15 meters per minute relative to the discharge openings. The 510 device also comprises ≥7 discharge openings.

The present invention relates to a process and an apparatus for applying a foamable reaction mixture onto a moving outerlayer, wherein the reaction mixture is applied onto the outerlayer from discharge openings and the outerlayer moves at a speed of ≥15 meters per minute relative to the discharge openings.

Composite elements made of an outerlayer and an insulating core are currently employed in many industry sectors. The basic construction of such composite elements consists of an outerlayer onto which an insulating material is applied. Employable outerlayers include for example sheets of coated steel, stainless steel, aluminum, copper or alloys of the two latter metals. Insulation panels made of a combination of outerlayers and an insulating core may also be produced. Plastics films, aluminum films, wood, glass fiber or mineral fiber nonwovens and also cellulose-containing materials such as paper, cardboard or papier-mâché may be used as outerlayer materials. Multilayered outerlayers made of aluminum and paper for example are often used. The choice of suitable outerlayer material depends on the intended field of application of the composite elements or insulation panel and the resulting material requirements. Employable insulating cores include in particular foams based on polyurethane (PUR) and/or polyisocyanurate (PIR).

Insulation panels are often employed in the construction of houses or apartments. In addition to the use of composite elements for insulation of chilled warehouses for example they are also ever more frequently employed as façade elements of buildings or as elements of industrial doors such as for example sectional doors. Such composite elements, also referred to hereinbelow as sandwich composite elements, exhibit through their outerlayer a stability and surface appearance corresponding to the material employed while the applied foam confers corresponding thermal insulation properties.

To produce corresponding insulation panels or composite elements a foaming reaction mixture is applied to a provided outerlayer by means of an application apparatus. When using foams based on isocyanates for example the corresponding polyol components and isocyanate components are mixed with one another and applied onto the outerlayer upon which they undergo foaming and curing.

Often used as the application apparatus for applying the foaming reaction mixture onto the outerlayer are tubes provided along their longitudinal extent with a plurality of bores from which the reaction mixture introduced into the tube may be discharged. Such tubes are typically referred to as rake applicators.

A technology known as “6-finger laydown” is known for high-speed production processes for such composite elements, known as high-speed rotors. This procedure also known as “American” or “US” technology employs three mixing heads each having two discharge apparatuses per mixing head. As a result of the three product streams it is possible to have here very different application mixtures (reaction activity states) over the width of the production plant which can result in problems with, for example, blowouts, cavities etc. Problems with running and mingling of the rising reaction mixture are often also encountered and can result in problems with dimensions. In the case of three mixing heads with their six product streams the cured foam strands may still be visually apparent in the end product which is regarded as a disadvantage.

EP 1 857 248 A2 describes an application apparatus for producing foams which are simultaneously applied and simultaneously foamed over the reaction area, wherein the apparatus comprises one mixing head, one distributor head and at least 3 or more discharge conduits attached to the distributor head which are secured to a rigid frame perpendicularly to the outflow direction. Also disclosed is an apparatus for producing sandwich composite elements or insulation panels which comprises at least two feed apparatuses for an upper and a lower outerlayer, a circulating belt for guiding the outerlayers, to which are connected in series an application apparatus for a foamed core layer, a molding sector and an apparatus for cutting to length.

WO 2010/089041 A2 discloses an apparatus for applying foamable reaction mixtures comprising a mixing head, a distributor head downstream of the mixing head, at least three discharge conduits attached to the distributor head, a feed of a component A to the mixing head, a feed of a component B to the mixing head, at least one static mixer for commixing an inert gas and the component A, the component B or a mixture of the components A and B, at least one feed on the high-pressure side for the highly-pressurized inert gas and at least one measurement and control unit for establishing the desired pressures of the components at the mixing head.

EP 2 233 271 A1 relates to an apparatus for applying foaming reaction mixtures comprising (a) a mixing head for mixing raw materials to produce the foam, (b) a distributor head downstream of the mixing head, (c) at least three hose conduits attached to the distributor head and (d) at least three stationary rake applicators for applyimg the mixture of the raw materials for foam formation onto a moving outerlayer.

EP 2 614 944 A1 describes an apparatus for applying a foaming reaction mixture onto an outerlayer, in particular for producing a composite element, comprising at least one rake applicator comprising a tubular hollow body, said hollow body extending along a central axis and comprising at least two discharge openings for discharging the foaming reaction mixture, and wherein the rake applicator and the outerlayer are movable relative to one another along a longitudinal axis. The central axis of the at least one rake applicator and the longitudinal axis of movement enclose an angle to one another of ≤80°.

EP 2 804 736 A1 discloses an apparatus for applying a foaming reaction mixture onto an outerlayer, in particular for producing a composite element, at least comprising two rake applicators each comprising a tubular hollow body, said hollow body extending along a central axis and comprising at least two discharge openings for discharging the foaming reaction mixture, wherein the rake applicators and the outerlayer are movable relative to one another along a longitudinal axis and wherein the rake applicators are arranged on a receiving element. The arrangement of the rake applicators on the receiving element in each case comprises an articulation by means of which the rake applicators are movably arranged on the receiving element and are alignable at an angle of ≤80° to the longitudinal axis of movement.

One alternative application technology is known as calibration. While this does result in a very high optical quality, control of the process in production is very difficult.

It is an object of the present invention to at least partially remedy the disadvantages in the prior art. It is a particular object of the invention to achieve a more homogeneous product quality over the width of an insulation panel or a foam composite element.

The object is achieved in accordance with the invention by a process as claimed in claim 1 and an apparatus as claimed in claim 4. Advantageous developments are specified in the subsidiary claims.

The present invention relates to a process for applying a foamable reaction mixture onto a moving outerlayer, wherein the reaction mixture is applied onto the outerlayer from discharge openings and the outerlayer moves at a speed of ≥15 meters per minute relative to the discharge openings, wherein the reaction mixture is applied onto the outerlayer from ≥7 discharge openings simultaneously.

An improvement in the pre-distribution of the reaction mixture into the contents of the present invention allows for substantially simpler control of the process and results in improved product quality after a shorter startup phase in production.

The process according to the invention is preferably a continuous process. It is suitable for the production of foam composite elements such as insulation panels in a high-speed production procedure. Depending on thickness the outerlayer speed is for example ≥10 to ≤70 meters per minute, preferably ≥15 meters per minute, more preferably ≥30 meters per minute.

Suitable outerlayers or substrates include for example metal films, in particular aluminum films, multilayer outerlayers, for example made of aluminum and paper, and plastics films. There is generally no limitation on the width of the outerlayer. For example the outerlayer may have a width between 1000 and 1300 mm, but a width of 2400 mm is also possible.

Suitable reaction mixtures include in particular a mixture which reacts to afford a polyurethane and/or polyisocyanurate foam. In one embodiment of the process according to the invention the reaction mixture therefore comprises a polyol A), a polyisocyanate B), optionally additives such as for example stabilizers and catalysts, optionally one or more flame retardants and one (or more) blowing agents C).

The polyol A) is preferably selected from the group of the polyether polyols, polyester polyols, polycarbonate polyols and/or polyether ester polyols. The OH number of the employed polyol or of the employed polyols may be for example >100 mg KOH/g to <800 mg KOH/g and the average OH functionality of the employed polyol or of the employed polyols is ≥2. In the case of a single added polyol the OH number indicates the OH number of said polyol. In the case of mixtures the average OH number is reported. This value may be determined in accordance with DIN 53240-2 (1998). The average OH functionality of the polyols is for example in a range from ≥2 to <6.

Polyether polyols that may be used include, for example, polytetramethylene glycol polyethers such as are obtainable by polymerization of tetrahydrofuran by cationic ring opening. Likewise suitable polyether polyols are addition products of styrene oxide, ethylene oxide, propylene oxide, butylene oxides and/or epichlorohydrin onto di- or polyfunctional starter molecules. It is usual to employ polyether polyols with ethylene oxide or propylene oxide as chain extenders.

Suitable starter molecules are for example ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and low molecular weight hydroxyl-containing esters of such polyols with dicarboxylic acids.

Employable polyester polyols include inter alia polycondensates of di- and also tri- and tetraols and di- and also tri- and tetracarboxylic acids or hydroxycarboxylic acids or lactones. Also employable for producing the polyesters instead of the free polycarboxylic acids are the corresponding polycarboxylic anhydrides or corresponding polycarboxylic esters of lower alcohols.

Examples of suitable diols are ethylene glycol, butylene glycol, diethylene glycol, triethylene glycol, polyalkylene glycols such as polyethylene glycol, and also 1,2-propanediol, 1,3-propanediol, 1,3-butanediol, 1,3-butanediol, 1,6-hexanediol and isomers, neopentyl glycol or neopentyl glycol hydroxypivalate. In addition, it is also possible to use polyols such as trimethylolpropane, glycerol, erythritol, pentaerythritol, trimethylolbenzene or trishydroxyethyl isocyanurate.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. Acid sources that may be used further include the corresponding anhydrides.

If the mean functionality of the polyol to be esterified is >2, it is additionally also possible to use monocarboxylic acids such as benzoic acid and hexanecarboxylic acid as well. Hydroxycarboxylic acids that may be co-used as reaction participants in the production of a polyester polyol having terminal hydroxyl groups are for example hydroxycaproic acid, hydroxybutyric acid, hydroxydecanoic acid, hydroxystearic acid and the like. Suitable lactones include caprolactone, butyrolactone and homologs.

Polycarbonate polyols that may be used are hydroxyl-containing polycarbonates, for example polycarbonate diols. These are obtainable by reaction of carbonic acid derivatives, such as diphenyl carbonate, dimethyl carbonate or phosgene, with polyols, preferably diols, or from carbon dioxide.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, and lactone-modified diols of the aforementioned type. Polyether polycarbonate diols may also be employed instead of or in addition to pure polycarbonate diols.

Employable polyetherester polyols are compounds containing ether groups, ester groups and OH groups. Organic dicarboxylic acids having up to 12 carbon atoms are suitable for producing the polyetherester polyols, preferably aliphatic dicarboxylic acids having >4 to <6 carbon atoms or aromatic dicarboxylic acids used singly or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Derivatives of these acids that may be used include, for example, their anhydrides and also their esters and monoesters with low molecular weight monofunctional alcohols having >1 to <4 carbon atoms.

Examples of suitable polyisocyanates B) include 1,4-butylene diisocyanate, 1,5-pentane diisocyanate, 1,6-hexamethylene diisocyanate (HDI), isophorone diisocyanate (IPDI), 2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) or higher homologs (polymeric MDI, pMDI), 1-3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1 to C6-alkyl groups.

In addition to the abovementioned polyisocyanates, it is also possible to use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

In the reaction mixture the ratio of the number of NCO groups in the isocyanate to the number of isocyanate-reactive groups may result in an index of 110 to 600. Preferably between 115 and 400. This index may also be in a range from >180:100 to <330:100 or else >90:100 to <140:100.

The reaction mixture further contains sufficient blowing agent C) as is required for achieving a dimensionally stable foam matrix and the desired apparent density. This is generally 0.5-30 parts by weight of blowing agent based on 100 parts by weight of the component A. Preferably employed blowing agents are physical blowing agents selected from at least one member of the group consisting of hydrocarbons, halogenated ethers and perfluorinated hydrocarbons having 1 to 8 carbon atoms. In the context of the present invention “physical blowing agents” are to be understood as meaning compounds which on account of their physical properties are volatile and unreactive toward the isocyanate component. The physical blowing agents to be used according to the invention are preferably selected from hydrocarbons (for example n-pentane, isopentane, cyclopentane, butane, isobutane), ethers (for example methylal), halogenated ethers, perfluorinated hydrocarbons having 1 to 8 carbon atoms (for example perfluorohexane) and mixtures thereof with one another. Also preferred is the use of (hydro)fluorinated olefins, for example HFO 1233zd(E) (trans-1-chloro-3,3,3 -trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluormethyl)pent-2-ene) and the use of combinations of these blowing agents. In particularly preferred embodiments the blowing agent C) employed is a pentane isomer or a mixture of different pentane isomers. It is exceptionally preferable to employ cyclopentane as the blowing agent C). Further examples of preferably employed hydrofluorocarbons are for example HFC 245fa (1,1,1,3,3-pentafluoropropane), HFC 365mfc (1,1,1,3,3-pentafluorobutane), HFC 134a or mixtures thereof. Different blowing agent classes may also be combined.

Also especially preferred is the use of (hydro)fluorinated olefins, for example HFO 1233zd(E) (trans-1-chloro-3,3,3 -trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4(or 2)-(trifluoromethyl)pent-2-ene and/or 1,1,1,3,4,4,5,5,5-nonafluoro-4(or 2)-(trifluoromethyl)pent-2-ene), alone or in combination with other blowing agents. These have the advantage of having a particularly low ozone depletion potential (ODP) and a particularly low global warming potential (GWP). The process according to the invention allows advantageous employment of (hydro)fluorinated olefins as blowing agents for composite systems since it allows production of composite elements having improved surface structures and improved adhesion to the outerlayer compared to composite elements produced with other application techniques.

Chemical blowing agents (also referred to as “co-blowing agents”) may be employed instead of or in addition to the abovementioned physical blowing agents. These are particularly preferably water and/or formic acid. The chemical blowing agents are preferably employed together with physical blowing agents. It is preferable when the co-blowing agents are employed in an amount up to 6% by weight, particularly preferably 0.5% to 4% by weight, for the composite elements based on the total amount of compounds having isocyanate-reactive hydrogen atoms in the component A.

Preferably employed for composite elements is a mixture of 0 and 6.0% by weight of co-blowing agent and 1.0% to 30.0% by weight of blowing agent in each case based on 100% by weight of the component A. However, the quantity ratio of co-blowing agent to blowing agent may also be from 1:7 to 1:35 according to requirements.

The reaction mixture optionally further contains a catalyst component D) which is suitable for catalyzing the blowing reaction, the urethane reaction and/or the isocyanurate reaction (trimerization). The catalyst components may be metered into the reaction mixture or else initially charged in the isocyanate-reactive component A) in full or in part.

Suitable therefor are in particular one or more catalytically active compounds selected from the following groups:

D1) aminic catalysts, for example amidines, such as 2,3-dimethyl-3,4,5,6-tetrahydropyrimidine, tertiary amines, such as triethylamine, tributylamine, dimethylcyclohexylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine-1,6, pentamethyldiethylenetriamine, bis(2-dimethylaminoethyl)ether, bis(dimethylaminopropyl)urea, dimethylpiperazine, 1,2-dimethylimidazole, N,N′,N″-tris(dimethylaminopropyl)hexahydrotriazine, bis [2-(N,N-dimethylamino)ethyl]ether, 1-azabicyclo-(3,3,0)-octane and 1,4-diazabicyclo-(2,2,2)-octane, and alkanolamine compounds, such as triethanolamine, triisopropanolamine, N-methyl- and N-ethyldiethanolamine, N,N-dimethylaminoethoxyethanol, N,N,N′-trimethylaminoethylethanolamine and dimethylethanolamine Particularly suitable compounds are selected from the group comprising tertiary amines, such as triethylamine, tributylamine, dimethylcyclohexylamine, dimethylbenzylamine, N,N,N′,N′- tetramethylethylenediamine, pentamethyldiethylenetriamine, bis(2-dimethylaminoethyl)ether, dimethylpiperazine, 1,2-dimethylimidazole and alkanolamine compounds, such as tris(dimethylaminomethyl)phenol, triethanolamine, triisopropanolamine, N-methyl- and N-ethyldiethanolamine, N,N-dimethylaminoethoxyethanol, N,N,N′-trimethylaminoethylethanolamine and dimethylethanolamine.

In a particularly preferred embodiment the catalyst component employs one or more aminic compounds having the structure:

(CH₃)₂N—CH₂—CH₂—X—CH₂—CH₂—Y

wherein Y=NR₂ or OH, preferably Y=N(CH₃)₂ or OH, particularly preferably Y=N(CH₃)₂

and wherein X=NR or O, preferably X=N—CH₃ or O, particularly preferably X=N—CH₃. Every R may be chosen independently of every other R and represents an organic radical

of any desired structure having at least one carbon atom. R is preferably an alkyl group having 1 to 12 carbon atoms, in particular C1- to C6-alkyl, particularly preferably methyl and ethyl, in particular methyl.

D2) carboxylates of alkali metals or alkaline earth metals, in particular sodium acetate, sodium octoate, potassium acetate, potassium octoate, and tin carboxylates, for example tin(II) acetate, tin(II) octoate, tin(II) ethylhexoate, tin(II) laurate, dbutyltin diacetate, dibutyltin dilaurate, dibutyltin maleate and dioctyltin acetate, and ammonium carboxylates. Sodium, potassium and ammonium carboxylates are especially preferred. Preferred carboxylates are formates, ethylhexanoates (=octoates) and acetates.

The catalyst preferably contains one or more catalysts selected from the group consisting of potassium acetate, potassium octoate, pentamethyldiethylenetriamine, N,N′,N″-tris(dimethylaminopropyl)hexahydrotriazine, tris(dimethylaminomethyl)phenol, bis [2-(N,N-dimethylamino)ethyl] ether and N,N-dimethylcyclohexylamine, particularly preferably from pentamethyldiethylenetriamine, N,N′,N″-tris(dimethylaminopropyl)hexahydrotriazine and N,N-dimethylcyclohexylamine, particularly preferably from pentamethyldiethylenetriamine, N,N′,N″-tris(dimethylaminopropyl)hexahydrotriazine and N,N-dimethylcyclohexylamine in combination with potassium acetate, potassium octoate or potassium formate or sodium formate.

In a preferred embodiment the catalysts required for producing the rigid foam, in particular aminic catalysts (D1) in combination with salts used as trimerization catalysts, are employed in an amount such that for example in continuously producing plants elements having flexible outerlayers can be produced at a rate of up to 80 m/min depending on element thickness.

The reactivity of the reaction mixture is generally adapted to the requirement using catalyst (or by means of other reactivity-enhancing components, for example aminopolyethers). Production of thin panels thus requires a reaction mixture having a higher reactivity than production of thicker panels. Cream time and fiber time are respectively typical parameters for the time taken for the the reaction mixture to begin to react and for the point at which a sufficiently stable polymer network has been formed. Typical cream times (characterized by commencement of foaming of the reaction mixture upon visual inspection) for processing using conventional techniques are in the range from 2 seconds to 50 seconds.

The process according to the invention now also allows advantageous processing of reaction mixtures having high or relatively high reactivities, i.e. cream times of <5 s, in particular <2 s, very particularly <1 s, and fiber times of <25 s, in particular <20 s and very particularly <14 s. The process according to the invention may be advantageous in particular for the production of thin panels since little material is available for combination here.

It is preferable to use a combination of catalyst components D1 and D2 in the reaction mixture. In this case the molar ratio should be chosen such that the D2/D1 ratio is between 0.1 and 80, in particular between 2 and 20. Short fiber times may be achieved for example with more than 0.9% by weight of potassium 2-ethylhexanoate based on all components of the reaction mixture.

The invention provides that the reaction mixture is applied onto the outerlayer from ≥7 discharge openings simultaneously. The higher the number of discharge openings, the lower the differences in product quality over the cross section of the obtained composite element (viewed transversely to the direction of movement of the outerlayer). The reaction mixture is preferably applied onto the outerlayer from 8 discharge openings simultaneously, more preferably applied onto the outerlayer from ≥12 discharge openings simultaneously, yet more preferably from ≥15 discharge openings.

The apparatus according to the invention is suitable for performing the process according to the invention. In such an apparatus according to the invention for applying a formable reaction onto a moving outerlayer, wherein the reaction mixture is applied onto the outerlayer from discharge openings, the apparatus comprises ≥7 discharge openings. The apparatus preferably comprises ≥8 discharge openings, more preferably ≥12 and yet more preferably ≥15 discharge openings.

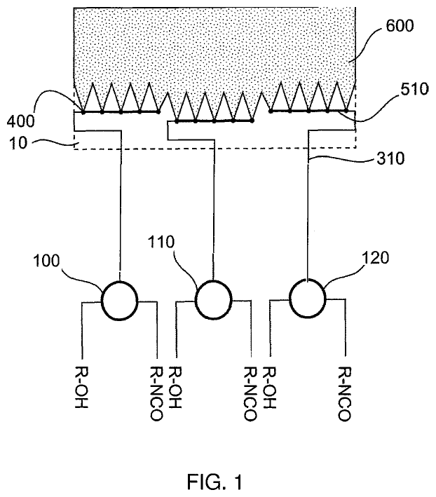

The present invention is more particularly elucidated with reference to the figures which follow without, however, being limited thereto. FIGS. 1, 2 and 3 show apparatuses according to the invention performing processes according to the invention.

The apparatus according to the invention and the process according to the invention shall be elucidated with reference to FIG. 1. The apparatus according to the invention further comprises:
a plurality of mixing heads 100, 110, 120, wherein each mixing head is adapted for mixing two or more reactant streams to afford one product stream;
a plurality of rake applicators 510, wherein the number of rake applicators corresponds to the number of mixing heads 100, 110, 120, each rake applicator is connected to a product stream of a mixing head and each rake applicator has ≥4 discharge openings 400.

Rake applicators employable here may, for example, be in the form of individual rake applicators or rake applicator pairs as described in EP 1 857 248 A2, EP 2 614 944 A1 or EP 2 804 736 A1. The feed to the rake applicator(s) may be central or lateral for example. Shown here is an apparatus comprising three mixing heads 100, 110 and 120. Each of these three mixing heads receives a product stream comprising a polyol component R-OH and a product stream comprising an isocyanate component R-NCO. It will be appreciated that the designations R-OH and R-NCO do not represent monoalcohols and monoisocyanates but rather generally polyols and polyisocyanates and blowing agents and other additives also present in these reactant streams.

The mixing heads 100, 110, 120 combine their reactant streams into product streams. The product streams thus contain the foamable reaction mixture. The reaction mixture exits the mixing heads via discharge conduits 310 which each terminate in rake applicators 510. In the embodiment shown in FIG. 1 each rake applicator has five discharge openings 400.

The three rake applicators 510 are arranged substantially side-by-side in FIG. 1. The fact that the middle rake applicator has been offset backward somewhat is intended to elucidate the fact that such rake applicators have certain space requirements which can prevent them being positioned directly side-by-side.

The reaction mixture exits the individual discharge oppenings 400 of the rake applicators 510 and contacts substantially over its entire width an outerlayer 10 which is moving away from the discharge openings and is represented by its dashed outline. Due to the expansion of the foaming reaction mixture the individual stripes of the reaction mixture combine to form the foam layer 600 on the outerlayer 10.

The process according to the invention performable with the apparatus according to the invention discussed hereinabove further comprises the steps of:
providing a plurality of mixing heads 100, 110, 120, wherein each mixing head is adapted for mixing two or more reactant streams to afford one product stream;
providing a plurality of rake applicators 510, wherein the number of rake applicators corresponds to the number of mixing heads 100, 110, 120, each rake applicator is connected to a product stream of a mixing head and each rake applicator has ≥4 discharge openings 400,
mixing two or more reactant streams in each of the mixing heads 100, 110, 120 to obtain a product stream exiting each of the mixing heads, wherein the product stream comprises a foamable reaction mixture;
applying the reaction mixture from the discharge openings 400 of the rake applicators 510 onto the outerlayer 10.

The number of mixing heads in these embodiments of the system according to the invention and of the process according to the invention may be 2, 3 (as shown here), 4, 5, 6 or more.

The number of rake applicators may be 2, 3 (as shown here), 4, 5, 6 or more. The number of openings per rake applicator may be 4, 5 (as shown here), 6, 7, 8, 9, 10 or more.

Rake applicators employable here may, for example, be in the form of individual rake applicators or rake applicator pairs as described in EP 1 857 248 A2, EP 2 614 944 A1 or EP 2 804 736 A1. The feed to the rake applicator(s) may be central or lateral for example This application methodology may be used for producing metal panel sandwich composite elements, insulation panels and continuous blocks.

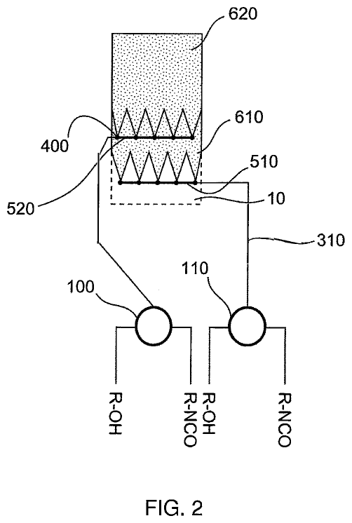

One embodiment of the system according to the invention and of the process according to the invention shall be elucidated with reference to FIG. 2. In the apparatus of the invention, at least two rake applicators 510, 520 are arranged one behind the other viewed in the direction of motion of the outerlayer.

The embodiment of the process according to the invention performable with the apparatus according to the invention discussed hereinabove furthermore has the feature that at least two rake applicators 510, 520 are arranged one behind the other (optionally with a slight offset) viewed in the direction of motion of the outerlayer so that the reaction mixture discharged from the discharge openings 400 of one rake applicator 510 at least partially contacts reaction mixture discharged from the discharge openings 400 of the other rake applicator 520. As shown in FIG. 2, the reaction mixture being discharged from rake applicator 510 in streams may flow between the streams of the other rake applicator 520 to achieve an even better mingling of the streams.

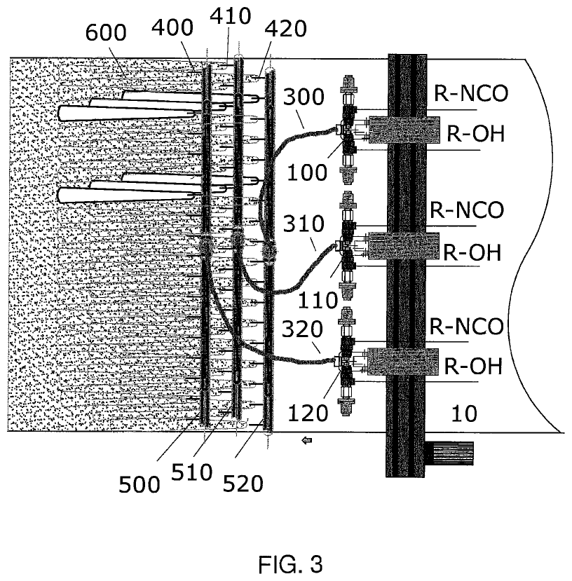

The maximum offset of the rake applicators with respect to one another depends on the number of rake applicators and the distance between the discharge openings. In a particularly preferred embodiment the offset of the rake applicators with respect to one another is not more than a length corresponding to 50% of the distance between two adjacent discharge openings of the rake applicators. One possible likewise preferred arrangement of three rake applicators 500, 510, 520 one behind the other is shown in FIG. 3. These are each offset with respect to one another by a length corresponding to about ⅓ of the distance between two adjacent discharge openings 400, 410 of the rake applicators, 500, 510, 520. Rake applicators employable here may, for example, be in the form of individual rake applicators or rake applicator pairs as described in EP 1 857 248 A2, EP 2 614 944 A1 or EP 2 804 736 A1. The feed to the rake applicator(s) may be central or lateral, for example

The number of mixing heads in these embodiments of the system according to the invention and of the process according to the invention may be 2 (as shown here), 3, 4, 5, 6 or more. The number of rake applicators may be 2 (as shown here), 3, 4, 5, 6 or more. The number of openings per rake applicator may be 4, 5 (as shown here), 6, 7, 8, 9, 10 or more.

The reaction mixture exits the individual discharge openings 400 of the rake applicators 510 and 520 and contacts substantially over its entire width an outerlayer 10 which is moving away from the discharge openings and is represented by its dashed outline. Due to the expansion of the foaming reaction mixture the individual stripes of the reaction mixture combine to form the foam layers 610, 620 flowing into one another on the outerlayer 10.

This application methodology may be used for producing metal panel sandwich composite elements, insulation panels and continuous blocks.

In all of the abovementioned discharge apparatuses discharging may be performed in the direction of the belt or counter to the direction of the belt. It may even be advantageous in one embodiment, as shown in one of the figures, when not all rake applicators are positioned at the same angle to the outerlayer.

1. A process for applying a foamable reaction mixture onto a moving outerlayer, wherein the reaction mixture is applied onto the outerlayer from discharge openings and the outerlayer moves at a speed of ≥15 meters per minute relative to the discharge openings,
wherein
the reaction mixture is applied onto the outerlayer from ≥7 discharge openings simultaneously, and wherein the process further comprises:
providing a plurality of mixing heads, wherein each mixing head is adapted for mixing two or more reactant streams to afford one product stream;
providing a plurality of rake applicators, wherein the number of rake applicators corresponds to the number of mixing heads, wherein each rake applicator is connected to the product stream of one of the mixing heads, and wherein each rake applicator has ≥4 discharge openings;
mixing two or more reactant streams in each of the mixing heads to obtain the product stream exiting each of the mixing heads, wherein the product stream comprises a portion of the reaction mixture; and
applying the reaction mixture from the discharge openings of the rake applicators onto the outerlayer.

2. The process as claimed in claim 1, wherein at least two rake applicators are arranged one behind the other viewed in the direction of motion of the outerlayer, and the reaction mixture discharged from the discharge openings of one rake applicator at least partially contacts the reaction mixture discharged from the discharge openings of a second rake applicator.

3. The process as claimed in claim 2, wherein the at least two rake applicators are arranged one behind the other viewed in the direction of motion of the outerlayer and are arranged offset with respect to one another so that the reaction mixture discharged from the discharge openings of a first rake applicator in streams flows between streams of the reaction mixture discharged from a second rake applicator.

4. The process as claimed in claim 3, wherein the at least two rake applicators are one behind the other as viewed in the direction of motion of the outerlayer and are offset with respect to one another by a length corresponding to not more than 50% of the distance between two adjacent discharge openings of the rake applicators.

5. The process as claimed in claim 4, wherein the at least two rake applicators are three rake applicators and are arranged one behind the other viewed in the direction of motion of the outerlayer.

6. The process as claimed in claim 1, wherein the reaction mixture comprises a polyol, a polyisocyanate and a blowing agent.

7. An apparatus for applying a foamable reaction mixture onto a moving outerlayer, wherein the reaction mixture is applied onto the outerlayer from discharge openings,
wherein
the apparatus comprises ≥7 discharge openings, and in that wherein the apparatus further comprises:
a plurality of mixing heads, wherein each mixing head is adapted for mixing two or more reactant streams to afford one product stream;
a plurality of rake applicators, wherein the number of rake applicators corresponds to the number of mixing heads, wherein each rake applicator is connected to the product stream of one of the mixing heads, and wherein each rake applicator has ≥4 discharge openings.

8. The apparatus as claimed in claim 7, wherein at least two rake applicators are arranged one behind the other viewed in the direction of motion of the outerlayer.

9. The apparatus as claimed in claim 8, wherein the at least two rake applicators are arranged one behind the other viewed in the direction of motion of the outerlayer and offset slightly with respect to one another.

10. The apparatus as claimed in claim 9, wherein the at least two rake applicators are offset by a length corresponding to not more than 50% of the distance between two adjacent discharge openings of the rake applicators.

11. The apparatus as claimed in claim 10, comprising three rake applicators.
